(19) United States
(12) Patent Application Publication
(10) Pub. No.: US 2002/0004974 A1
(43) Pub. Date: Jan. 17, 2002

(54) METHOD FOR MANUFACTURING A LOW SELF-INDUCTANCE CAPACITOR

(76) Inventors: HARALD VETTER, HEIDENHEIM (DE); LUDWIG BERG, HEIDENHEIM (DE)

Correspondence Address: SCHIFF HARDIN & WAITE, Patent Dept., 6600 Sears Tower, CHICAGO, IL, 60606, US

(21) Appl. No.: 09/269,593

(22) PCT Filed: Aug. 25, 1997
(86) PCT No.: PCT/DE97/01846

(30) Foreign Application Priority Data
Sep. 27, 1998 (DE) 196 39 882.7

(51) Int. Cl. B21F 41/00; H01G 7/00

(52) U.S. Cl. 29/25.42; 29/868; 29/854

(57) ABSTRACT

In a method for producing an electric capacitor, installed in a housing, of low self-inductance, Litz wires (2) interconnect the capacitor connection elements (1) and bushings (6). Use is made of Litz wires (2) with an essentially circular cross-section, and before being inserted into the bushings (6) the Litz wires (2) are centrally compacted at least at an end (7) arranged in the bushings (6).

The invention relates to a method for producing an electrical capacitor, installed in a container, of low self-inductance, in which Litz wires interconnect the capacitor connection elements and bushings.

Capacitors, in particular power electronics capacitors of extremely reduced self-inductance have been generally known for a long time. Thus, for example, EP 05 98 256 A1 discloses a radial GTO snubber capacitor which comprises a low-inductance capacitor element which is installed in a container with the smallest possible cable spacing from the connection elements (bushings).

In the course of the development of semiconductors, there has been a further requirement to reduce the self-inductance values, in particular of large capacitors in the rectangular container (for example for use in intermediate circuit batteries), to values ≦50 nH. These extremely low values can be achieved, inter alia, only by means of a minimized cable spacing of the finally connected element stack from the connection element (bushing), and by an increase in the number of component capacitors per capacitor container with the number of bushings associated therewith.

At present, capacitors are produced with four to six bushings (that is to say two to three component capacitors connected in parallel). However, this approach to solving the reduction of the capacitor self-inductance requires a very high dimensional accuracy of the individual structural elements in the connecting region of the capacitor.

The situation is compounded by the necessity which arises from case to case of, for example, employing the capacitor cover, with the bushings, as a pre-completed part, and pushing the capacitor installation, comprising the finally connected and insulated element stacks, into the container, as a rule from the container in an “upside down” fashion since, for reasons of production engineering, in the case of these design variants the capacitor cover must generally already be present finally welded in during final mounting.

The reasons set forth necessarily entail that the individual terminal studs of the capacitor package must be threaded very precisely. This method is naturally complicated and attended by risks in connection with the mechanical stability of the individual structural elements (for example terminal studs and bushings).

The possibility of separating capacitor packages into individual stacks in order thus to have to insert “only” two terminal studs from the bottom into the bushing bores on the cover side goes only part of the way to alleviate the problems of dimension and mounting.

An attempt has therefore been made to connect the capacitor installation to the bushings by flexible connecting cables (Litz wires). In this structural embodiment of a low-inductance power capacitor, Litz wires make contact with the element stacks and are then threaded via the bore of the bushing and tightly soldered. The difficulties in this embodiment consist in that the self-inductance in the region of the end of the element stack is substantially higher than in the case of interconnection in accordance with the prior art set forth above. The embodiment with interconnection by Litz wires which has been outlined is also more complicated (and thus more expensive) to produce, since in some cases threading into the cover region requires a large quantity of Litz wires which must be removed before or after the bushings are tightly soldered, and thus can be disposed of only as waste.

It is the object of the present invention to specify a cost effective method which permits a connection which is very short and thus of extremely low inductance between one or more capacitor element stacks and, correspondingly, one or more bushings in conjunction with the use of Litz wires.

This object is achieved according to the invention by virtue of the fact use is made of Litz wires with an essentially circular cross-section, and in that before being inserted into the bushings the Litz wires are centrally compacted at least at an end to be arranged in the bushings.

Advantageous embodiments of the subject-matter of the invention are set forth in the subclaims.

The invention is explained in more detail below with the aid of exemplary embodiments.

In the associated drawing:

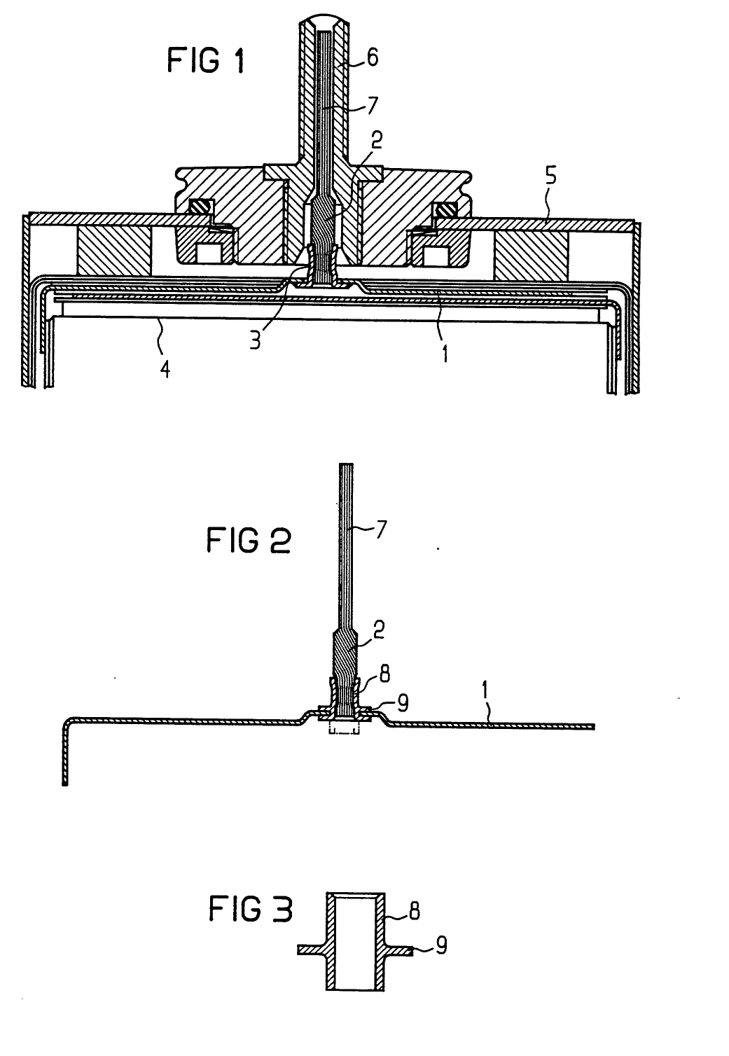

FIG. 1 shows a Litz wire arranged in a bushing,

FIG. 2 shows a Litz wire riveted into a capacitor connection part, and

FIG. 3 shows a part of flange-shaped construction.

Represented in FIG. 1 is a capacitor connection element 1 into which a Litz wire 2 is inserted. In a fashion analogous to a cable lug mounting (for example with hexagonal crimping), the Litz wire 2 is pressed into the connection element 1 by means of an appropriately shaped connection part 3. Subsequently, the Litz wire 2 and capacitor connection element 1 can be soldered together. After final mounting or complete installation of the element stack 4, two flexible, short pieces of Litz wire are available which are already finally connected to the capacitor connection element 1 on the bottom side.

The end-mounted element stack 4 is now placed on the bottom side onto the container with the container cover 5, already welded in and prepared, with the bushings 6 arranged therein. In this arrangement, the Litz wire 2 is threaded into the bores of the bushings with a centrally compacted upper end 7, and the element stack 4 (or the complete installation) is subsequently pushed into the container. For the purpose of better manipulation, a threading wire can be arranged in the centrally compacted end 7, as a result of which the insertion and withdrawal of the Litz wire 2 can be improved. In the next step, the compacted end 7 of the Litz wire 2 is then soldered tightly in the bushing 6, it also being possible, if appropriate, to undertake crimping.

Represented in FIG. 2 is a further embodiment, in which by means of a part 8 constructed in the shape of a flange, the Litz wire 2 is fitted and crimped together on one side with the Litz wire 2 compacted at the opposite end 7. The piece of Litz wire prefabricated in this way is riveted into the capacitor connection element 1, a step 9 represented in FIG. 3 ensuring that despite the riveting an adequately dimensioned soldering gap remains on the top side of the capacitor connection element 1 for the purpose of soldering the part 8 or the Litz wire 2.

It is to be gathered from the exemplary embodiments set forth above that a Litz wire 2, precompacted in an end region 7, in the threading region of the bushing 6 is dimensionally stabilized in a way which permits mounting with pre-completed container covers 5 without appreciable dimensional problems with or, if appropriate, without a threading wire. This permits cost effective production of a capacitor of low self-inductance.

The uncompacted zone of the Litz wire 2 is certainly comparatively short, but can nevertheless, as it were, take over a “universal joint function”, it being ensured thereby that it becomes possible to set considerably lower requirements for the dimensional stability of the structural elements of the capacitor. In addition, a larger diameter or cross-section of the Litz wire is realized than would be the case without compaction. This means that relatively higher current intensities become possible than in the case of a design without compaction. This effect is important in connection with the upward tendency of the current intensities per component.

In particular, the subject-matter of the invention also permits the difficult variant of the “upside down mounting” of the element stack 4 with the cover 5 welded in with a plurality of bushings 6, to be mastered even without a threading wire.

The proposed solution is particularly advantageous in the connection region of a capacitor in the case of radio-frequency current components, because thermal relief of the bushings results in this case.

1. Method for producing an electrical capacitor, installed in a container, of low self-inductance, in which Litz wires interconnect the capacitor connection elements and bushings, characterized in that use is made of Litz wires (2) with an essentially circular cross-section, and in that before being inserted into the bushings (6) the Litz wires (2) are centrally compacted at least at an end (7) arranged in the bushings (6).

2. Method according to claim 1, characterized in that before the compaction a wire serving as a threading aid is arranged in the centre of the Litz wires (2) in the region of the end (7).

3. Method according to claim 1 or 2, characterized in that before the Litz wire (2) is installed in the capacitor connection element (1), this end of the Litz wire is also centrally compacted.

4. Method according to one of claims 1 to 3, characterized in that for the purpose of installing the Litz wire (2) in the capacitor connection element (1), use is made of a part (8) which is of flange-shaped construction, is crimped to the end of the Litz wire, and is riveted to the capacitor connection element (1).

5. Method according to claim 4, characterized in that the capacitor connection element (1) is riveted, and in that the part (8) of flange-shaped construction is additionally soldered to the capacitor connection element (1).
